(19) United States
(12) Patent Application Publication
(10) Pub. No.: US 2008/0096169 A1
(43) Pub. Date: Apr. 24, 2008

(54) Abacus for Math and English

(76) Inventor: Ye-Eun Kim, Wonju (KR)

Correspondence Address: PARK LAW FIRM, 3255 WILSHIRE BLVD, SUITE 1110, LOS ANGELES, CA, 90010, US

(21) Appl. No.: 11/574,171

(22) PCT Filed: Aug. 24, 2005
(86) PCT No.: PCT/KR05/02788

§ 371 Date: Feb. 23, 2007

(30) Foreign Application Priority Data
Aug. 24, 2004 (KR) 10-2004-0068798
Oct. 1, 2004 (KR) 10-2004-0090076
Mar. 11, 2005 (KR) 10-2005-0021298

(51) Int. Cl. G09B 1/06

(52) U.S. Cl. 434/159; 434/188

(57) ABSTRACT

Disclosed herein, a new concept of numeral created from alphabet is able to apply in education, telecommunication, computer and toy industry. For the sake of applicability, the present invention provides substitution methods where alphabet is replaced to the corresponding arabic numeral by similarity in shape, similar pronunciation with numbers, similarity in Roman and Chinese. In education, alphabetic language (English, French, Spanish) learners can calculate words and sentences in mathematics (abacus calculation, mental arithmetic, calculation), and learn words and sentences of languages in detail. Math (abacus calculation, mental arithmetic, calculation) learners can study alphabetic languages (English, French, Spanish) not in a tedious repetition of calculation but in a mathematical learning process. In telecommunication and computer industry, for instant input of letters, the alphabet letters are arranged to the corresponding numeral keys by similarity between alphabet and arabic numeral, and the number key, which reminds letters, is pushed designated times to input accordingly. In toy industry, diverse educational toys can be manufactured to learn substitution methods proposed in the disclosed herein.

### TECHNICAL FIELD

The present invention relates to a new concept of numeral created from alphabet, and relates to a record media, which can be read through computer used a program referring the present invention, such as learning method, teaching materials, teaching tools, playthings, telecommunication terminal and computer keyboard.

The present invention provides a method that a new concept of numeral is able to be used like a typical numeral in the industry of education, telecommunication, toy, computer, where a traditional arabic numeral is used.

### BACKGROUND ART

Alphabet is the most common language in the world where 141 countries use as a mother tongue. A numeral is the fundamental tool in mathematics which is commonly used world wide.

Up to now, proficiency of words and sentences in alphabetic languages has highly been depended on reading and writing.

In addition, in the case of math (abacus calculation, mental arithmetic) learners, the process is tedious repetition of numeral calculation.

Due to students' high demand learning abacus calculation, piano and foreign languages, the coordinated learning programs have been explored, however there is no significant alternative plan.

In telecommunication and computer industry, the alphabet on keyboard is randomly arranged without certain standard, and it resulted inconvenience to memorize the arrangement.

### DISCLOSURE OF INVENTION

### Technical Problem

The present invention intends to use alphabet like arabic numeral in the field of education, telecommunication, and computer.

The invention also intends to accomplish alphabetic language learning, such as English, French, and Spanish, and Math (abacus calculation, mental arithmetic) education simultaneously.

And then, the invention intends to improve the arrangement of alphabetic letters on telecommunication terminal or computer keyboard for facile memory.

To solve the issues as mentioned above, the present invention provides methods how to express alphabetic languages to mathematical numeral.

Since alphabet contains 26 letters and the arabic numeral does 10 numbers, one to one replacement is not possible. It has been issued commonly and has not been tried substitution, however there is no reasonable correlation between alphabet and numeral.

Therefore, the logic of substitution of alphabet to the corresponding numeral can be concluded. Regardless of intermediate process, it could be successful if the substitution process that everyone can learn easily is obtained. Accordingly, the substitution method as a intermediate process is the only matter in terms of how it is effective for facile memory.

### Technical Solution

Hereinafter, the details are explained referred by the attached figures. Typical techniques are supposed to be omitted.

FIG. 1 presents the substitution method of alphabet to the corresponding numeral, the method is organized for easy understanding and use in worldwide when everyone gets some clues.

In addition, depending on languages, the method prescribes in the exceptional rules that a substitution is done by a similar pronunciation between alphabet and numeral. In a standard protocol, the capital and small alphabetic letters are not discriminated.

Few standards are disposed as follow; Substitution by similarity in shape, similarity with Korean, similarity in Roman numeral, and similarity in pronunciation, such as o (oh)=5,e(e)=2.

Two embodiments, showing similarity in pronunciation between korean and numeral, concern facile memory for Korean students.

English and French are same in shape. Besides, other languages use the fundamental alphabets in duplicate, or use alphabets with dots and/or other signs, however, in principle, the duplicated letters calculate in duplicate and dots and other signals don't be counted. In addition, depending on a language situation, the letters can be substituted to a arbitrary numeral.

Others than 26 fundamental letters are substituted to 1. In the case that the letters are similar to the corresponding numeral in a shape can be substituted accordingly.

Once the technique for full knowledge of substitution method is performed as followed, low grade elementary students could understand and express shortly.

Principle of Substitution and Organization of learning method

1. Substitution by similarity in shape (The most recommended embodiment)

‘a’ and 6 are mirror image with bowing shape.

‘b’ and 6 are similar in a shape.

‘c’ is similar to 7 where 7 is in a position of laid down sideway.

‘d’ is similar to 6 where 6 is in a position of turning against.

‘e’ is in a shape of 9 where 9 is turned around.

‘f’ is similar to 1 where 1 is stretched two arms out and bowed.

‘g’ is similar to 8 (or 9).

‘h’ is similar to 7 (or 6).

‘i’ is similar to 1 where 1 is in the rain.

‘j’ is similar to 1 where 1 is worn a rain boots.

‘k’ is similar to 4.

‘l’ looks alike 1.

‘m’ is similar to 3 where 3 is laid down.

‘n’ is similar to 7.

‘o’ is similar to 0.

‘p’ is similar to 9 where 9 is turned against.

‘r’ is similar to 1 where 1 is stretching arms out and being punished.

‘s’ is similar to 5 where 5 is dancing.

‘t’ is similar to 7 where 7 is standing in the position of the upside down.

‘u’ is similar to 7 where the upside of 7 is down.

‘v’ means 5 in Roman character (or the upside of 7 is down).

‘w’ is similar to 3 where 3 is laid down sideway.

‘x’ is similar to 4 somehow where 4 is in a standing position with straightening its waist.

‘y’ is similar to 9 where 9 takes off a hat.

‘z’ is similar to 2.

Along with the substitution method, words, sentences, and grammar are expressed and calculated during learning process of Math (abacus calculation, mental arithmetic included).

Especially, speed, handiness of iterative learning and possibility of verification that are distinctive features in Abacus calculation are applicable to learning language.

A new keyboard, demonstrating facile memory of letters, is designed.

Important questions in education

Student: Is there any problem that each numeral possesses several alphabet letters once substitution is done by a similarity in shape?

Teacher: There is no problem.

Substitution of alphabet to numeral according to similarity is to memorize alphabetic languages such as English, French and Spanish. Therefore, it is emphasized when 26 alphabet letters are substituted to 10 different numbers in numeral, the present invention reminds instantly without delay. Due to such a rationale, some numbers are changed with several alphabetic letters and others are done with less number of letters.

The reason why 1 possesses 5 letters is that 1 is negotiated the efficiency in calculation in terms of calculation speed, and others except 1 are substituted to alphabetic letters to be memorized and 1 is substituted the rest of letters.

Regardless substitution to numeral, once expressed on a abacus, it does not read numbers but read alphabetic letters.

It is supposed to pronounce alphabetic languages such as English, French and Spanish.

Student: In terms of alphabet education, What is the role of numeral in substitution of alphabet to numbers?

Teacher: The role of numeral is to induce an answer through abacus and to confirm students' accomplishment of learning. In the process, students improve learning of spell and Math (abacus calculation and mental arithmetic) simultaneously.

Student: When we try as described above, how long does it take to memorize the substituted numeral?

Teacher: It takes about 5 minutes but you can acquire instantly, and you also can refer a substitution table that is attached on abacus for a couple of confused numbers. However, even it won't be needed within few days.

Student: Why 0 doesn't exist?

Teacher: o (oh) is corresponded to 0 (zero). It looks like same in shape. For Korean student, Exception type 1 in FIG. 1 shows that it is substituted to 5.

### Advantageous Effects

As described, the present invention provides simultaneous learning effect of alphabetic languages such as English, French, and Spanish and Math (abacus calculation and mental arithmetic).

Herewith, it provides the outstanding mean of substitution for learning alphabet, and in the Math learning process, the unnecessity is eliminated resulting an effective learning method. Individual letters also can be memorized.

As the present invention assumes that the learning is based on abacus, once the abacus function is practised, it can prepare the outstanding calculation capability. As someone becomes skillful, the expert can perform through image in his/her mind without abacus. This fact is already testified in abacus calculation, and the present invention also employed the same principle that recognize alphabet to the corresponding numeral.

When this function is applied to computer and telecommunication industry, it makes simple input of letters.

### BRIEF DESCRIPTION OF THE DRAWINGS

FIG. 1 is an embodiment of substitution method of alphabetic languages, English, French, and Spanish, to the corresponding numeral.

FIG. 2 is an embodiment of substitution method and a calculation process in the present invention showing the words in alphabetic languages is changed to the corresponding numeral.

FIG. 3 is an embodiment of substitution method and a calculation process showing each words are changed to the corresponding arabic numeral.

FIG. 4 is an embodiment showing a textbook referring the present invention.

FIG. 5 is an embodiment showing a textbook referring the present invention.

FIG. 6 is an embodiment showing each abacuses present individual languages by the present invention.

FIG. 7 is an embodiment showing toys referring the present invention.

FIG. 8 is an embodiment showing a computer keyboard referring the present invention.

FIG. 9 is an embodiment of keyboard of general cellular phone.

FIG. 10 is an embodiment showing a cellular phone keyboard referring the present invention.

FIG. 11 is a flow chart of alphabet input showing an embodiment that a cellular phone keyboard refers the present invention.

FIG. 12 is an embodiment of textbook referring the present invention.

FIG. 13 is an embodiment of textbook referring the present invention.

### BEST MODE FOR CARRYING OUT THE INVENTION

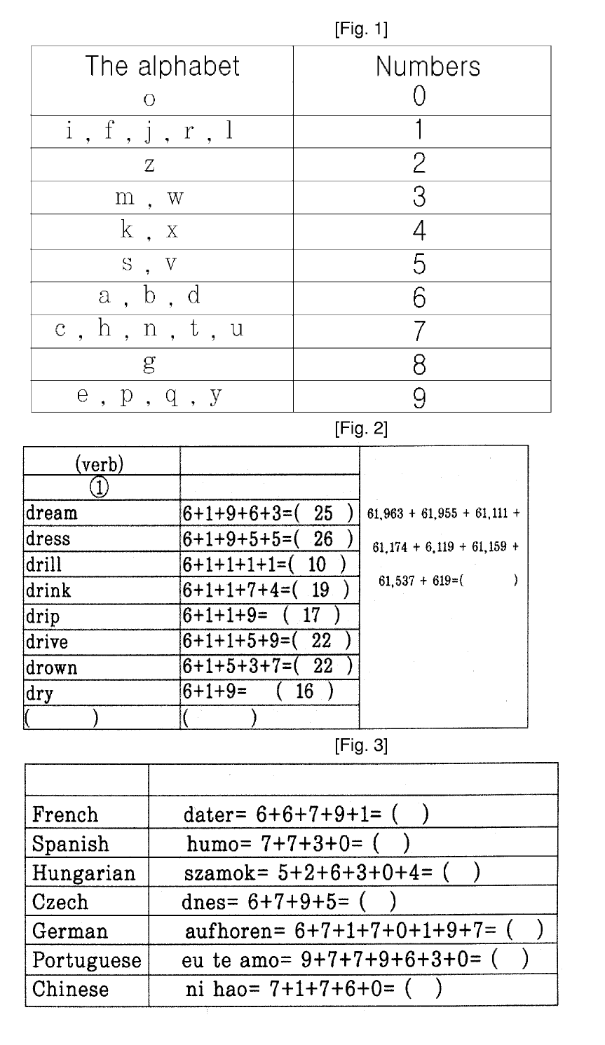

The Embodiment of FIG. 1 is the most prominent and will become a standard method. It presents a substitution method of alphabet to numeral, and is organized to understand without difficulty for everyone if some clues are given.

In a standard, the alphabetic capital/small letters are not distinguished.

As applied in education industry, FIG. 2 is an embodiment showing a method how to designate alphabet words to numeral. Depending on students' level, the beginner can organize as oneth digit letters, the middle- and higher level of expert can organize as the words have their own digits. The words containing a number of letters can be divided and calculated accordingly. Where (3+5+9+1+9) is (1+5) your (9+5+7+1) faith (1+6+1+7+7).

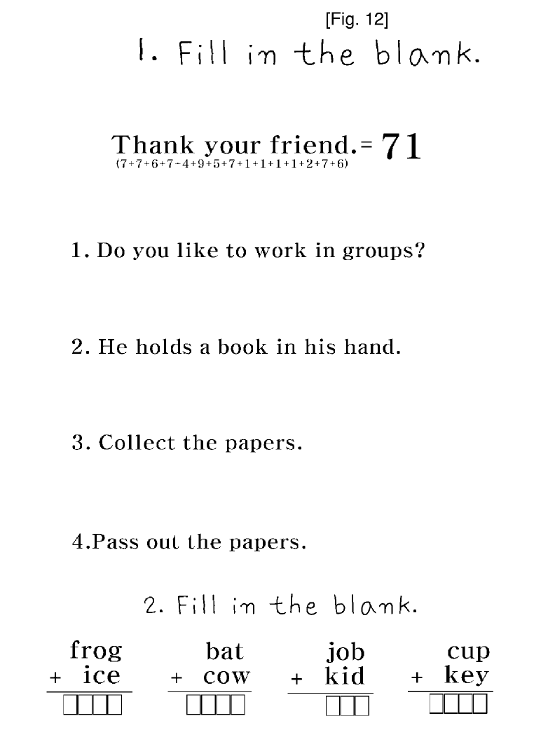

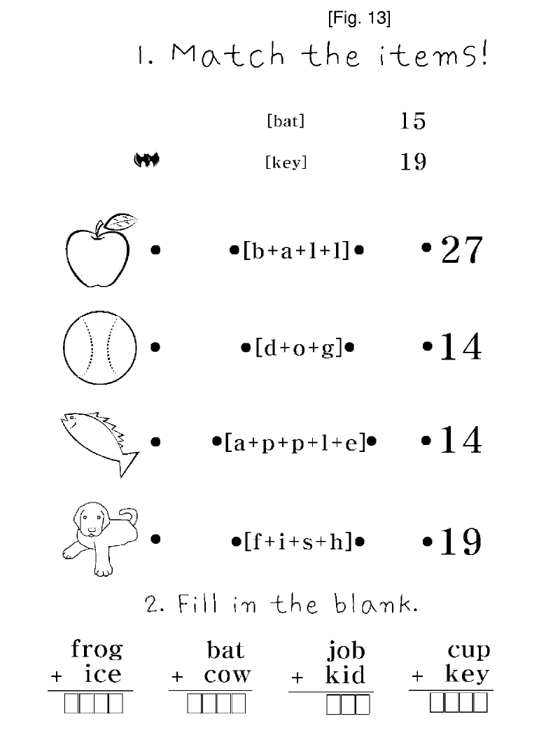

The textbooks, referred the present invention, are provided as general reference books (FIG. 12 and FIG. 13), and also provided as record media that can be operated in an internet system, computer and electronic devices after programmed. In the case of internet system and record media, it can be printed out to learn or selected the program in the computer by students' level and grade in school and then studied.

As applied in telecommunication industry, FIG. 10 is an embodiment showing a component diagram of keys where the letters are arranged and designated followed by similarity between alphabet and numeral.

1=f, i, j, l

2=z, :, ?

3=m, w or e (E), m, w

4=k, x

5=s, v

6=a, b, d, h

7=c, n, u, t

8=g, r (R)

9=e, p, q, y or p, q, y

0=o, @-, /, ., !

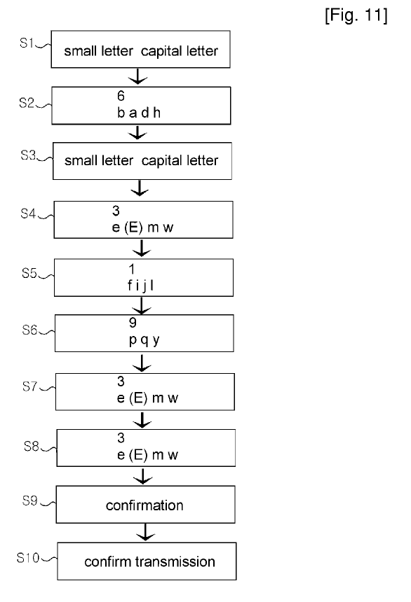

FIG. 11 is an embodiment showing a flow chart of input of letters. Through the process, “Help me” can be completed as follows; the initial stage (S1) to change to a capital letter mode; the S2 stage, process the key of number 6 four times in a row to input H; the S3 stage, to change to a small letter mode; the S4 stage, press the key of number 9 once to input e; the S5 stage, press the key of number 1 four times to input 1; the S6 stage, press the key of number 9 once to input p; the S7 stage, press the key of number 3 once to input m; the S8 stage, press the key of number 3 once to input e; the S9 stage, press the confirmation key once to confirm input; the final stage, press the confirmation key to complete forward.

### Mode for the Invention

When alphabet is substituted to the corresponding numbers from 1 to 9,
a=1, b=2, c=3, d=4, e=5, f=6, g=7, h=8, I=9 j=1, k=2, l=3, m=4, n=5, o=6, p=7, q=8, r=9 s=1, t=2, u=3, v=4, w=5, x=6, y=7, z=8.

When capital letters are used, A=4, B=8, D=0, E=3, F=4 or G=9, L=7, Q=9, R=2 or 8.

The way of arbitrary decision of numbers can be done in games and recreation as means which makes students skillful. It also can be punitive rule to students who memorize answer of known words and calculate without using abacus.

Pros and Cons of embodiments are described below.

The embodiment of 1 shows an advantage of equal distribution, however it takes time to memorize, easy to forget and needs a substitution table. The embodiment of 6 shows confusion with small alphabetic letters.

FIG. 3 shows a method how to present alphabetic words, such as French, Spanish, Hungarian, German and Czechoslovakian to numeral by abacus. Depending on students' level, the beginner can organize as the oneth digit letters, the middle- and higher level experts can organize as words have their own digits. The words containing lots of letters can be divided and calculated accordingly.

FIG. 4 shows a method how to present English sentence on an abacus.

FIG. 5 shows an embodiment of textbook referred the present invention. The question 1 of the present embodiment shows that the question is organized by only verbs having own gerunds. As follows repetition of decades times, Students can memorize a group of verbs that adopt gerunds as objectives. This embodiment can be applied to other grammars.

During presentation and calculation on abacus, it is emphasized that the substituted numbers shouldn't be pronounced but aware, however, the alphabets in languages and pronunciation of words have to be presented.

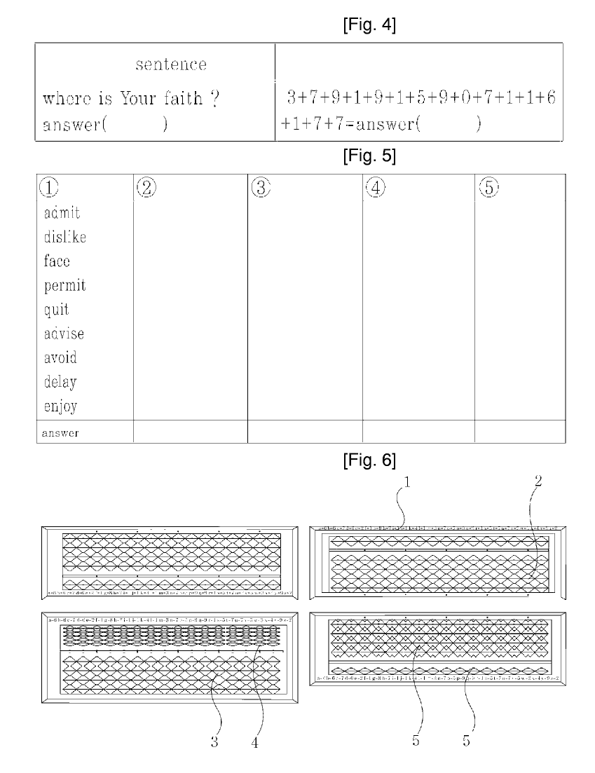

FIG. 6 is an embodiment showing a standard substitution method of individual languages on the exclusive abacus. It is similar to the general abacus where the conventional function is revised completely by printing of standard substitution method so that the beginner can refer.

An abacus can be proceeded with a substitution table (1). Color in the third line of downside beads is for the sake of facile memory. Once the alphabet is reminded through abacus, a relatively difficult base line (3) of cipher and the third line (2) of downside beads are differentiated by different color.

For clear understanding of the meaning of numbers which are presented by abacus beads, as an embodiment is given, the exclusive abacus is organized as the quintuplets (4) beads presenting 5, the twin beads (5) presenting 2, and the abacus beads (6) presenting 1.

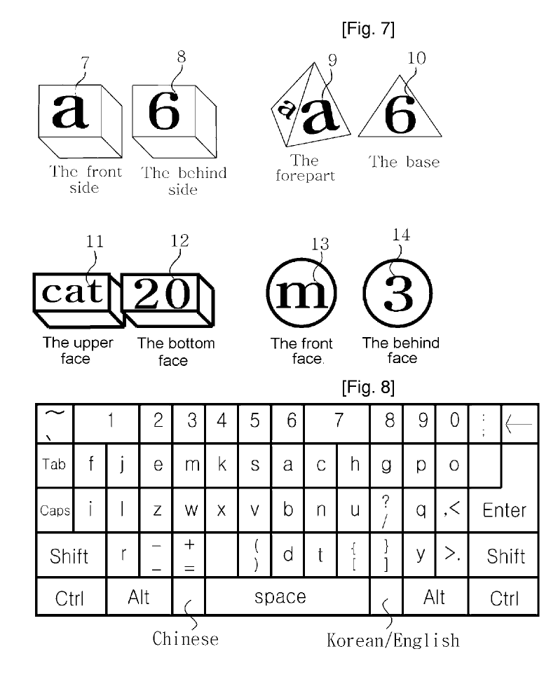

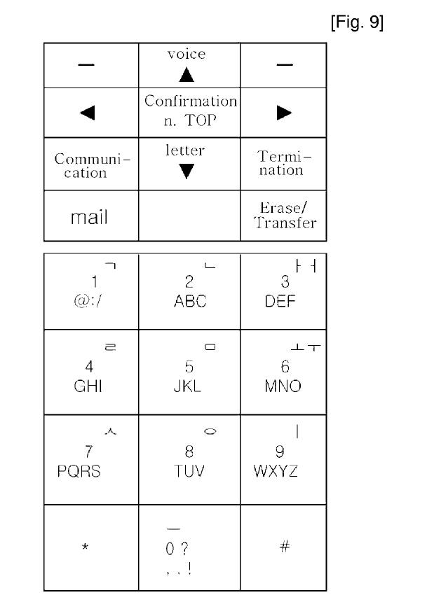

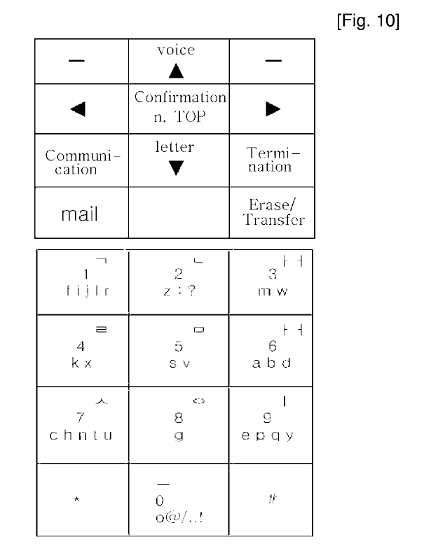

FIG. 7 is an embodiment of toys referred the present invention. To fluent adoption of a substitution method, alphabet (7) and substituting number (8) are imprinted on the front face and the behind face, respectively.

In the case of triangle, alphabet (9) and substituting numbers (10) are imprinted on the front and behind face.

In the case of cone, alphabet (11) and numbers (12) are imprinted on the front face and the behind face, respectively.

The front face of sticker is imprinted in English words (13), and the bottom face is imprinted in numbers (14). The embodiments shown are can be used for the amusement education.

FIG. 8 is an embodiment of arrangement of letters on a keyboard which refers the present invention. The numbers, similar to the corresponding alphabet letters, are designated at the bottom of number key for facile memory.

These embodiments are the only part of description of the present invention, even though the description is modified to a different organization, this is still in the scope of the claims.

### INDUSTRIAL APPLICABILITY

Until now on, the embodiments are mainly explained through English which is representative alphabetic language, however the same effect is expected to other alphabetic languages such as French and Spanish. Especially, the present invention is valuable to a fundamental Math and learning alphabet for students in preschool and low grade elementary school. In Korea, several thousands of franchise branches of Math (abacus calculation) education are existed. There is a worldwide educational industry which is sharing 10% of GDP. English is being understood as a required language in Korea, China, and japan. The present invention provides an excellent factor to the educational industry.

Since the present invention uses alphabet and numeral that are spoken and referred in worldwide, it can be supported in diverse. Especially, regardless asian countries using abacus, or other countries using alphabetic languages, such as English, French and Spanish, the learning of vocabularies and letters is critical for language education, and the invention can be referred to the educational process. In reference, the alphabet is used in the following countries; English in 53 countries (Gana, Guyana, Gambia, Grenada)

French in 28 countries (Gabong, Guinea, Niger, Rewanda)

Spanish in 27 countries (Guatemala, Nicaragua, Republic of Dominica, Mexico)

Portuguese in 7 countries (Brazil, Mozambique, Republic of SanTome and Principe, Angola)

Italian in 5 countries (Italy, Vatican, San Marino, Somalia, Swiss)

German in 4 countries (Germany, Austria, Swiss, Liechtenstein)

Serbian in 3 countries (Yugoslavia, Croatia, Bosnia)

Czechoslovakian in 2 countries (Czecho, Slovakia)

Dutch in 2 countries (Netherlands, Surinam)

Additional Norwegian, Swedish, Danish, Hungarian, Turkish, Georgian, Greek, Polish, Rumanian, Irish.

Overall, more than 141 countries are using their own languages, and for French, its alphabet is same as other languages such as English and Spanish. Spanish is also basically same and additional few letters are simply in repetition of letters so that there is no difficulty to refer the present invention.

Other languages, Dutch, Norwegian and Danish, use alphabet commonly and the present invention can be referred accordingly. In addition, when learn foreign languages, most of countries can refer the present invention. Therefore, application of the invention can be expanded to worldwide.

Especially, the effect of abacus is proved for a long period of time. Since the present invention expresses alphabet through numeral iteratively, it is an universal concept where the words are memorized by repetition, merely, the substitution method is invented. Therefore, everyone can understand easily through step by step instruction.

Nowadays, as abacus becomes prominent as a mean of development of intellectual faculty, the present invention, pursuing development of mathematical intellectual faculty as well as language education, could be an excellent commodity.

The present invention can be used at keyboard of telecommunication terminal. Due to use of word message, the input of alphabet by keyboard becomes facile.

In the current generation where the combination of education with play is prevalent, the present invention could be an important factor for production of the creative toys and games recognizing alphabetic letters to numeral.

1. An integrated learning method using an alphabet and mathematics (abacus calculation, writing calculation and mental arithmetic), in which letters of each of alphabetic languages, including English, French, Spanish, Portuguese, German, Italian, Czechoslovakian, Dutch, Norwegian, Swedish, Danish, Hungarian, Icelandic, Serbian, Moldovian, Turkish, Rumanian, Irish, Georgian, Greek, Russian, Polish, Finnish, Esperanto, Latvian, Estonian, and Chinese Pronunciation Standard Transcription, are substituted for arbitrary Arabic numerals for the calculation of the substituted Arabic numerals, the method comprising:
substituting the fundamental alphabetic letters for Arabic numerals in a one to one ratio, such as for example, a=6, b=6, c=7, d=6, e=9 or 2, f=1, g=8 or 9, h=7 or 6, I=1, j=1, k=4, l=1, m=3, n=7, o=0 or 5, p=9, q=9, r=1, s=5, t=7, u=7, v=5 or 7, w=3, x=4, y=9, and z=2;
substituting other letters, completely different from the twenty-six fundamental alphabetic letters, for 1 without condition; and
substituting some alphabetic capital letters for Arabic numerals in a one to one ratio, such as for example, A=4, B=8, D=0, E=3, F=4 or 9, G=9, L=7, Q=9, R=8, and H=2 or 8.

2. A recording media for use with teaching tools, teaching aids, toys, electronic devices and computers, comprising:
a mathematical teaching aid for enabling integrated learning of an alphabet and mathematics (abacus calculation, writing calculation and mental arithmetic), so that letters of each of alphabetic languages, including English, French, Spanish, Portuguese, German, Italian, Czechoslovakian, Dutch, Norwegian, Swedish, Danish, Hungarian, Icelandic, Serbian, Moldovian, Turkish, Rumanian, Irish, Georgian, Greek, Russian, Polish, Finnish, and Chinese Pronunciation Standard Transcription, are substituted for arbitrary Arabic numerals in a one to one ratio for the calculation of the substituted Arabic numerals, based on an alphabet substitution table included in the mathematical teaching aid.

3. An abacus for integrated learning comprising:
a mathematical teaching aid for enabling integrated learning of an alphabet and mathematics (abacus calculation, writing calculation and mental arithmetic), so that letters of each of alphabetic languages, including English, French, Spanish, Portuguese, German, Italian, Czechoslovakian, Dutch, Norwegian, Swedish, Danish, Hungarian, Icelandic, Serbian, Moldovian, Turkish, Rumanian, Irish, Georgian, Greek, Russian, Polish, Finnish, and Chinese Pronunciation Standard Transcription, are substituted for arbitrary Arabic numerals in a one to one ratio for the calculation of the substituted Arabic numerals, based on an alphabet substitution table included in the mathematical teaching aid, and
wherein beads constituting a third row from the bottom of the abacus are colored to have a predetermined color different from that of the remaining beads, to facilitate calculation of the alphabetic letters using the alphabet substitution table.

4. The abacus as set forth in claim 3, wherein a specific part of the beads, which constitute an uppermost row of the abacus representing Arabic numeral 5, are integrally formed in groups of five, and a first bead of each group serving as a standard bead is colored to have a predetermined color different from that of the other beads of the group, for easy recognition of a calculated numerical result represented by the beads.

5. The abacus as set forth in claim 3, wherein upper half of the beads are integrally formed in groups of two so that the numerical value of 2 is granted, and the remaining lower half of the beads is individually formed so that the numerical value of 1 is granted, for easy application of the alphabetic letters.

6. A keyboard for use with telecommunication terminals and computers, comprising:
a plurality of alphabetic letter keys and numeral keys arranged based on the shape similarity of alphabetic letters and numerals for convenient input of the alphabetic letters,
whereby fundamental alphabetic letters are substituted for Arabic numerals in a one to one ratio, such as for example,
a=6, b=6, c=7, d=6, e=9 or 2, f=1, g=8 or 9, h=7 or 6, I=1, j=1, k=4, l=1, m=3, n=7, o=0 or 5, p=9, q=9, r=1, s=5, t=7, u=7, v=5 or 7, w=3, x=4, y=9, z=2;
other letters, completely different from the twenty six fundamental alphabetic letters, are substituted for 1 without condition; and
some alphabetic capital letters are substituted for Arabic numerals in a one to one ratio, such as for example, A=4, B=8, D=0, E=3, F=4 or 9, G=9, L=7, Q=9, R=8, H=2 or 8.

7. The keyboard as set forth in claim 6, wherein the alphabetic letters are directly printed on the numeral keys of a telecommunication terminal, or the alphabetic letter keys are arranged beneath the numeral keys of a computer keyboard, so that the alphabetic letters are substituted for Arabic numerals as follows:
1=f, i, j, l
2=z, :, ?
3=m, w or e (E), m, w
4=k,
532 s, v
6=a, b, d, h
7=c, n, u, t
8=g, r (R)
9=e, p, q, y or p, q, y
0=o, @ -, /, ., !
